(19) United States
(12) Patent Application Publication
(10) Pub. No.: US 2015/0169303 A1
(43) Pub. Date: Jun. 18, 2015

(54) COMPILER OPTIMIZATION FOR FINITE STATE MACHINES

(71) Applicant: QUALCOMM Incorporated, San Diego, CA (US)

(72) Inventors: Weiming Zhao, San Diego, CA (US); Zine-el-abidine Benaissa, San Diego, CA (US)

(73) Assignee: QUALCOMM Incorporated, San Diego, CA (US)

(21) Appl. No.: 14/106,628

(22) Filed: Dec. 13, 2013

(51) Int. Cl. G06F 9/45

(52) U.S. Cl. CPC G06F 8/4441

(57) ABSTRACT

An optimizing compiler performs optimization that can employ complex transformations of the compiler input—such as transition table transpose of a transition table for a finite state machine and finding “hot spots” of the finite state machine—and provides compiled code for finite state machines that is more efficient (with regard either to time efficiency or space efficiency or both) than compiled code provided by general purpose optimizing compilers, which generally can not perform complex transformations like transition table transpose for finite state machines. Compiled code may be optimized for particular hardware for an embedded system. Performance of a finite state machine executing in hardware is optimized by finding states and transitions of the finite state machine that occur more or most frequently, referred to as “hot spots”, and generating optimized code tailored to execute the finite state machine more quickly, or using less instructions, for those states and transitions.

### BACKGROUND

The present disclosure generally relates to computer systems and architecture and, more particularly, to compilers for producing compiled code to implement finite state machines on embedded systems in such a way that the compiled code is customized, for efficient execution, to each finite state machine and the embedded system on which the finite state machine is to be implemented.

The finite state machine (FSM) is ubiquitous in computer science applications such as string processing for web technology. In embedded systems—such as a processor of a mobile device, smartphone, or tablet—a finite state machine is commonly used in communication message parsing (e.g., parsing for XML or HTML messaging systems), lexical analysis of script languages (e.g., Perl, sed), or regular expression matching, for just a few examples. The performance of an embedded system with regard to execution of a particular finite state machine can be very sensitive to a number of hardware and software factors including: instruction cache locality, code size, and branch prediction miss rate. Performance of an embedded system executing code for an FSM, compared to code for a typical application (e.g., not an FSM) executed on a non-embedded system, can be more susceptible, for example, to indirect branching (which is implicit in the use of switch statements commonly used to implement an FSM) due to less powerful branch prediction and to code size due to smaller instruction cache. Given a representation (using, e.g., some high level programming language) of a particular finite state machine that is to be implemented by compiling the representation into computer readable and executable code, an optimizing compiler should be able to generate optimally efficient code (e.g., code that is in some sense as efficient as possible) that is optimized both for the particular structure and features of the particular FSM being implemented and for the hardware of the embedded system on which the FSM is being implemented.

For example, finite state machines are often represented in a high level language using a switch statement that chooses one of several cases, each case corresponding to a state of the FSM. In a straightforward, “one-size-fits-all” compilation of such a switch statement, each case of the FSM checks the current input and transitions to the next state by resetting the state; execution of the compiled code then loops back to the top (or “outside”) level of the switch statement and transitions to the next state by choosing the case corresponding to the next state; and execution repeats this way until a terminal state of the FSM is reached. For a finite state machine having one or more particular structures—such as a state with many inputs that transition back to the same state—compiled code that revisits the top level of the switch statement each time may be capable of more efficiency by executing far fewer code instructions, and by taking less time to reach the terminal state of the FSM on the same input. The code size (e.g., number of instructions of the compiled code implementing the FSM) can also be reduced so that the compiled code for this example can be not only more time efficient (faster) but also more space efficient (smaller).

In general, a software developer will implement an FSM with source code that is humanly readable in furtherance of the goal that software will operate correctly, or as intended. It is then left up to the compiler to generate compiled code that is more efficient than the readable code, but still correct, or at least as correct as the code the compiler receives as input. Such compiler optimization of source code generally is inadequate for customizing code to a particular hardware implementation and provides general optimizations that are not specific to finite state machine implementations.

One example of such compiler optimization of input source code is successive-case direct branching, in which, for example, if case A of a switch statement is always followed by case B, the compiled code shortcuts the trip back to the top of the switch statement by branching directly to case B from case A. This optimization typically eliminates redundant comparisons (by shortcutting the top of the switch statement) but pays for increased speed with greater code size (e.g., duplication of various cases), which may be unacceptable to a particular embedded system.

Also, existing general purpose optimizations for compiled code that typically are limited by the input code shape (e.g., the high level programming language representation of the FSM), generally can not perform complex transformations required to find effective optimizations for finite state machines.

### BRIEF DESCRIPTION OF THE DRAWINGS

FIG. 1 is a schematic system diagram illustrating a computer system and processes for operating a compiler for optimizing finite state machines, according to an embodiment.

FIG. 2 shows an example of a source code input such as that referred to in FIG. 1, in accordance with one or more embodiments.

FIG. 3 shows a state transition table representation of a finite state machine used as an example to illustrate operation of one or more embodiments.

FIG. 4 shows some examples of source code transformations used as an example to illustrate operation of one or more embodiments.

FIG. 5 is a graphical representation of a portion of a finite state machine used as an example to illustrate operation of one or more embodiments.

FIG. 6 is a graphical representation of a portion of a finite state machine used as another example to illustrate operation of one or more embodiments.

FIG. 7 is a diagram showing a transformation of source code text used as an example to illustrate operation of one or more embodiments.

FIG. 8 is a process flow diagram illustrating a method for operating a compiler for optimizing finite state machines, in accordance with one or more embodiments.

FIG. 9 is a block diagram of an example of a computer system suitable for implementing on one or more devices of the computing system in FIG. 1, according to one or more embodiments.

Embodiments of the present disclosure and their advantages are best understood by referring to the detailed description that follows. It should be appreciated that like reference numerals are used to identify like elements illustrated in one or more of the figures, in which the showings therein are for purposes of illustrating the embodiments and not for purposes of limiting them.

### DETAILED DESCRIPTION

In accord with one or more embodiments, a compiler with optimization that can employ complex transformations of the compiler input—such as transition table transpose of a transition table for a finite state machine and finding “hot spots” of the finite state machine—provides compiled code for finite state machines that is more efficient (with regard either to time efficiency or space efficiency or both) than compiled code provided by general purpose optimizing compilers, which generally can not perform complex transformations like transition table transpose for finite state machines. State transition systems (e.g., finite state machines) tend to be expensive in terms of resources used (e.g. execution time, memory space occupied by executable code) in hardware, which can be an important design factor for embedded systems—such as processors for mobile devices, smartphones, and tablets—so optimizing state transitions to minimize or improve resource consumption of finite state machines can vitally affect commercial viability for many embedded systems.

Performance of a finite state machine executing in hardware may be improved, for example, in terms of finding states and transitions of the finite state machine that occur more or most frequently, referred to as “hot spots”, and generating optimized code tailored to execute the finite state machine more quickly, or using less instructions, for those states and transitions. In addition, the optimized code can be tailored for states and transitions of the finite state machine to avoid or minimize penalty incurred in increased code size. Such code size optimization may be specifically targeted toward the hardware on which the optimized code for the finite state machine is to execute.

More particularly, a finite state machine optimization may be provided by a finite state machine optimizing compiler system that first recognizes a finite state machine (FSM) in the input (e.g., source code or intermediate representation) to the system and re-constructs a state transition table for the finite state machine that is input to the system. The system then analyzes the re-constructed state transition table to find certain key features present in the input finite state machine and applies optimizations specific to those key features. The optimizations may include, for example, determining hot spots, performing transition table transpose transformations, eliminating redundancies, and state in-lining. The optimizations may be applied to construct an optimized transition table for the input finite state machine. Based on the optimized state transition table, the optimizing compiler may generate new code that implements the finite state machine that was input to the system. In addition the new code may be optimized for target hardware on which the finite state machine is to be implemented.

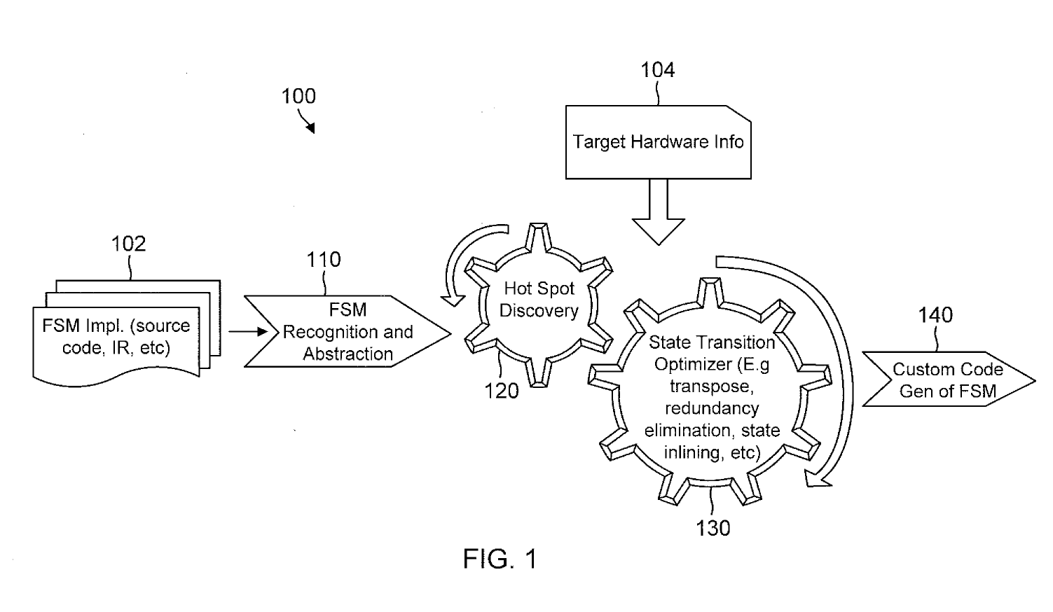

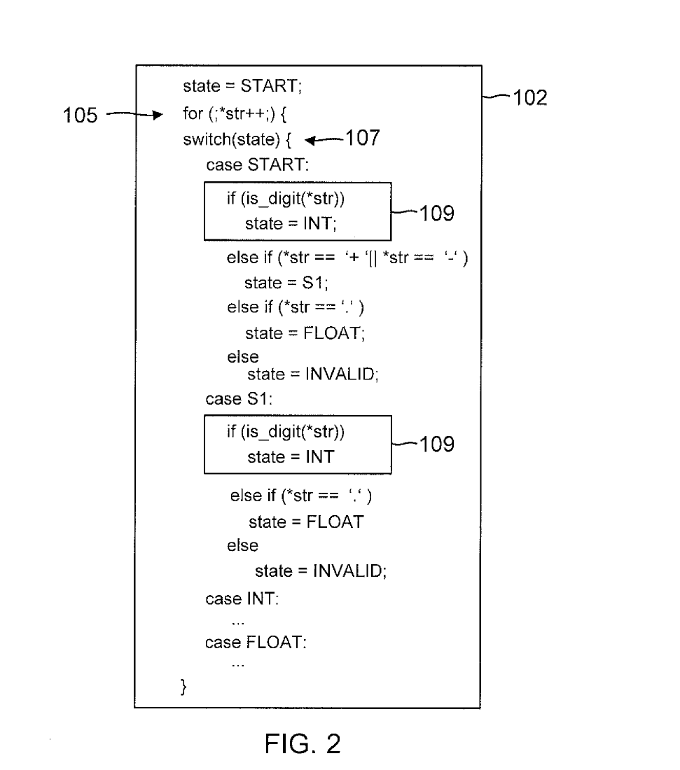

FIG. 1 illustrates system 100 for an optimizing compiler for implementing finite state machines, according to one or more embodiments. System 100 may receive an input 102 comprising a finite state machine implementation represented by source code, or an intermediate representation (IR), or other form of input character string representation. An example of a source code input 102 is shown in FIG. 2. System 100 also may receive an input 104 comprising information about specific hardware for which output code (e.g., compiled code) is to be generated. Specific hardware information input 104 may include, for example, specific limitations and constraints of the hardware, such as instruction cache locality and instruction cache size.

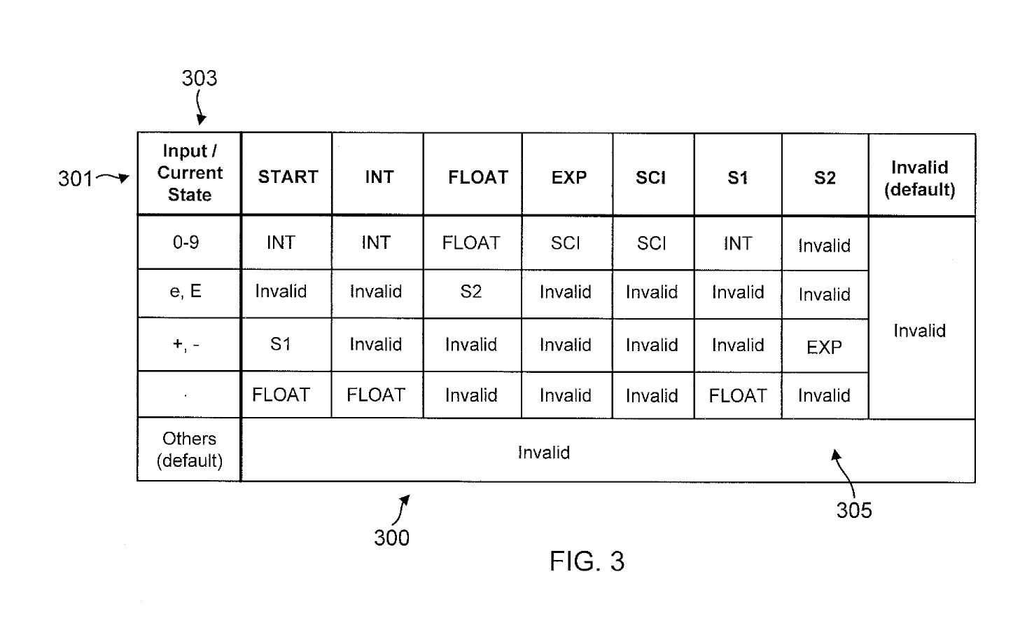

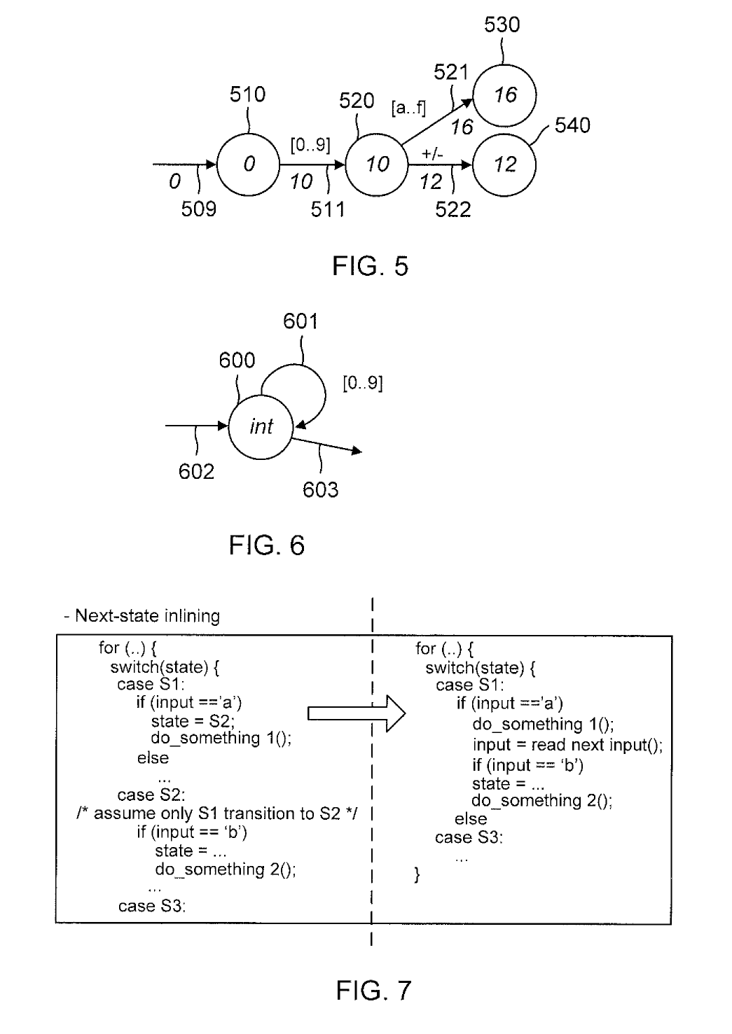

System 100 may perform finite state machine recognition and abstraction 110 on source code input 102 using, for example, various operations of lexical analysis, parsing, and pattern recognition to provide an abstract or canonical representation of a finite state machine represented by source code input 102. For example, finite state machine recognition and abstraction 110 may provide as a canonical representation a state transition table representation of a finite state machine, an example of which is shown in FIG. 3, or a graphical representation of a finite state machine, examples of which are shown in FIGS. 5 and 6.

System 100 may perform “hot spot” discovery 120 using the canonical representation (e.g., state transition table 300) of the finite state machine represented by source code input 102. A hot spot may be described as a state of the finite state machine that is transitioned into more frequently than other states, and may often be recognized by particular structures of the finite state machine, such as a “tight loop”, an example of which is shown in FIG. 6. A number of heuristics may be used to facilitate hot spot discovery 120, including recognizing hot spots by performing a transpose transformation of the canonical state transition table representation of a finite state machine and recognizing patterns in the transposed state transition table that are specific to hot spots.

System 100 may perform state transition optimization 130 using the canonical representation of the finite state machine (e.g., canonical representation of the finite state machine represented by source code input 102) and any indications from hot spot discovery 120 as to the existence and locations of hot spots in the finite state machine represented by the canonical representation.

Based on the canonical representation of the finite state machine received as input (e.g., the finite state machine represented by source code input 102) and hot spot discovery 120, and using various transformations for the finite state machine—such as any or all of state transition table transpose, redundancy elimination, elimination of unreachable states, or next state in-lining—and taking the hardware information input 104 into account, system 100 may provide a state transition optimization 130 for the input finite state machine (e.g., the finite state machine represented by source code input 102) that, combined with custom code generation 140 produces compiled code that takes into account various factors and constraints such as hot spots of the finite state machine, required execution speed including faster execution for the most frequented hot spots, and amount of memory available in hardware for the executable code to reside.

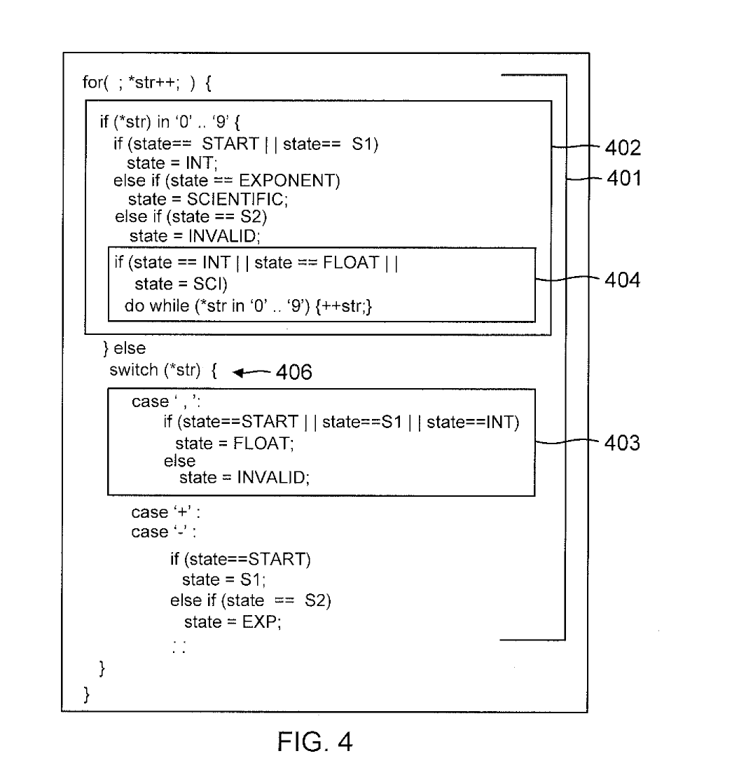

FIG. 2 shows an example of a source code input 102 such as that referred to in FIG. 1. As seen in FIG. 2, source code input 102 may include a character string that may conform to some particular grammar so that source code input 102 may be parsed. Source code input 102 may be recognizable as source code for implementing a finite state machine, and may thus be said to represent a finite state machine. The example seen in FIG. 2 shows a portion of a kernel loop (implemented by “for” statement 105) for executing the finite state machine until it reaches a terminal state. Nested inside the kernel loop (“for” statement 105) is a switch statement 107, whose semantic interpretation for executing or operating the finite state machine is to check the current state of the finite state machine. A switch statement 107 generally may include a case branch of the switch statement for each state of the finite state machine represented by source code input 102. Nested inside switch statement 107, generally one for each case or finite machine state, are compare statements 109, the purpose of which for operating the finite state machine is to check the current input to the finite state machine for determining which transition to follow from the current state. Thus, the example source code input 102 shown in FIG. 2 may be briefly described as a kernel loop with an outer switch that checks the current state with inner compare statements that test the input to the finite state machine. Source code for a finite state machine may be arranged alternatively so that a kernel loop has outer compare statements that test the input to the finite state machine while inner statements check the state of the finite state machine. This alternative arrangement may be said to be a transpose of the source code input 102. An example of a portion of such a transposed source code is shown in FIG. 4.

FIG. 3 shows a state transition table 300 that may be derived from source code input 102 to provide an abstract or canonical representation of the finite state machine that would operate when source code 102 is executed on a processor. Header row 301 indicates a state of the finite state machine for each column. Left border column 303 indicates current input to the finite state machine. For a given state in the header row 301, the table entries 305 listed in the column below that state, for each row, indicate the next state to be transitioned to when the current input is as appears in the same row of the left border column 303. Thus, given a state transition table such as state transition table 300 and desiderata of source code that checks current state first then checks input, source code input 102 can be reconstructed. A transpose of the source code input 102—that checks input first then checks current state, such as seen in FIG. 4—can also be constructed either directly from source code input 102, from state transition table 300, or from a table transpose of state transition table 300. (A table transpose may be formed by flipping a table, such as table 300, about a diagonal from the upper left corner extending to the right and down, as known in the art.)

An implementation-independent, or canonical, representation, such as state transition table 300, for a finite state machine represented by a source code input, such as source code input 102, may be constructed as follows.

Source code input 102 may undergo a “function in-lining” process to expand predicates and functions in the source code into basic operators of the source language. For example, “isDigit( )” may be expanded to “if (x>=‘0’ && x<=‘9’)”. The process of finite state machine recognition and abstraction 110 may also include a process for converting source code 102 into static single assignment (SSA) form. Source code 102 may be processed to recognize various grammatical constructs such as loops, variables, and actions to be performed.

When a loop is encountered in the source code input 102, finite state machine recognition and abstraction 110 may perform processes that include A) identifying state variables, B) identifying state transitions, C) identifying input variables, D) populating a transition table, and E) identifying actions.

A) A process of identifying a state variable (S) may include recognizing that each loop iteration will check the current state and generate the next state. So the process may include recognizing: 1) a state variable S is initially having a constant value (the initial state); 2) the value of S is compared with a constant (examining the current state); and 3) whenever the value of the state variable S is updated, the new value is still a constant, i.e. the next state is decided.

B) A process of identifying state transitions may include tracking all instructions from the state comparison (where the value of S is compared with a constant, examining the current state, as in (2) above) to either the end of the loop or the last occurrence where S is updated.

C) A process of identifying an input variable (V) may include examining, for each state transition identified by (B), all comparisons to determine whether all of the comparisons are between a common variable and a constant; if so, this common variable is input variable V.

D) A process of populating a transition table may include providing a state variable entry (such as table entries 305) for each cell of the transition table based on the information identified in (A), (B), and (C). The process of finite state machine recognition and abstraction 110 may check that there is no unknown cell (missing table entry) or overlapping cell (conflicting table entries).

E) The process of finite state machine recognition and abstraction 110 may include a process of identifying actions, which may include identifying as actions the rest of the instructions other than those instructions used for state transition condition checking in the program or execution trace of the finite state machine represented by source code 102.

FIG. 4 shows some examples of transformations that may be performed by system 100 on source code input 102 or on a canonical representation-such as state transition table 300—of a finite state machine represented by source code input 102. Transformation 401 is an example of a transposed switch: FSM input is checked first, followed by state checking as can be seen in FIG. 4. Transformation 401 may provide the following advantages: transformation 401 may be executed as a single hot block, giving better instruction cache performance; transformation 401 shows an example of simplified logic: the example shown has only 3 branches; and transformation 401 may condense the number of cases (4 cases for the FSM inputs vs. 8 cases for the FSM states) providing a more efficient switch table.

Transformation 402 is an example of hoisting hot transitions out of a switch statement. Hot spots may be recognized using one or more heuristics such as the one illustrated with reference to FIG. 5. For a finite state machine for string-to-number parsing, as in the present example, digits ‘0’ . . . ‘9’ are likely to be encountered as FSM input more frequently compared to other inputs such as ‘e’, ‘E’; ‘+’, ‘−’; ‘.’; or other characters, and thus may be recognized as hot transitions. Inspection of FIG. 4 reveals that, rather than including the case of input ‘0’ . . . ‘9’ in switch statement 406, transformation 402 covers input of digits ‘0’ . . . ‘9’ separately while only the remaining input cases are covered by switch statement 406. Transformation 402 can be seen to implement the first (“0-9”) row of state transition table 300, covering all the states of the finite state machine represented by state transition table 300.

Transformation 402 may provide the following advantages: transformation 402 may avoid the use of a jump table or indirect branching in generating compiled code to implement the finite state machine given its canonical representation, e.g., state transition table 300.

Transformation 403 provides an example of state merging: for FSM input ‘.’ and looking at the third (input=‘.’) row of state transition table 300, each of states “START”, “INT”, and “S1” transitions to state “FLOAT” on input ‘.’ while each of the remaining states transitions to “Invalid”. Thus, the “START”, “INT”, and “S1” states can be merged, as seen in the example code shown as transformation 403. Transformation 403 may provide the following advantage: transformation 403 may provide smaller code size compared to providing code for each of the unmerged states separately.

Transformation 404 is an example of state loop generation for a looped state. An example of a looped state of a finite state machine is illustrated graphically by FIG. 6. The “int” state 600 and transitions shown in FIG. 6 may be seen to correspond to the “INT” state of state transition table 300.

For example, transition 601, which loops back to state 600 corresponds to the first (input=“0-9”) row, second (state=INT) column of state transition table 300 marked INT which indicates that state INT with input “0” . . . “9” transitions to INT state. Similarly, transition 602, which transitions into the “int” state 600, may be seen to correspond, for example, to first (input=“0-9”) row, sixth (state=S1) column of state transition table 300 also marked INT which indicates that state S1 with input “0” . . . “9” transitions into the INT state. Likewise, transition 603, which transitions out of the “int” state 600, may be seen to correspond, for example, to fourth (input=“.”) row, second (state=INT) column of state transition table 300 marked FLOAT which indicates that state INT with input “.” transitions transitions out of the INT state into the FLOAT state.

As shown in the first (input=“0-9”) row of state transition table 300, the FLOAT and SCI states similarly loop to themselves on input 0-9, and, as seen in FIG. 4, transformation 404 combines the three looped states (INT, FLOAT, and SCI) into the single section of generated code, as shown, for better locality of the generated compiled code, further reducing code size and increasing efficiency for the three looped states at once.

FIG. 5 is a graphical representation of a portion of a finite state machine such as may represented by a source code input, such as source code input 102, or state transition table 300, and is used to illustrate application of a heuristic for discovering hot spots, e.g., hot states or hot transitions, those that are executed more frequently by the finite state machine when it receives its expected input strings. Benefits of discovering hot spots include applying special optimization to hot spots for maximizing benefit-to-cost for generation of more efficient compiled code. For example, optimizations that trade code size for performance-such as successive case direct branching, e.g., compiled code that directly inserts code that handles the next state into the end of current state handling—may be selectively applied only to hot spots so that a positive trade-off can be achieved and a negative trade-off can be avoided. Also, for example, compiled code may be generated with a layout that groups hot spots together, avoiding redundancy for smaller code size.

The heuristic example illustrated in FIG. 5 may estimate relative frequency of FSM states and transitions for discovering hot spots under an assumption that frequency of inputs is more or less uniformly distributed so that transitions that take multiple inputs (e.g., transition 601 shown in FIG. 6 or the first (input=“0-9”) row of state transition table 300) are potential hot spot transitions. The heuristic example illustrated in FIG. 5 may estimate relative frequency by calculating a weight for each state and transition; then, states and transitions ending up with the highest weights may be deemed to be hot spot states and transitions (or hot states, hot transitions). To apply the heuristic example illustrated in FIG. 5, all states (e.g., states 510, 520, 530, 540) initially receive a weight of zero. Thus, transition 509 and state 510 are shown in FIG. 5 with their initial weights. For a transition that takes n inputs, the weight of its to-state is increased by n, reflecting the probability that the to-state is more likely to be entered. Thus, the weight of to-state 520 of transition 511 is increased by 10, the number of inputs [0 . . . 9] taken by transition 511. The weight of each transition is computed as the weight of its from-state+n. Thus, the weight of transition 511 is computed as 0+10. Proceeding in this manner, it can be seen that transition 521, which takes six inputs [a . . . f], receives weight 10+6=16 as shown, and the initial weight, 0, of its to-state, state 530, is increased by 16. Continuing computing in this manner, the weights of transition 522 and state 540 can be seen to be as shown in FIG. 5. State 530 and transition 521, having the highest weights, may be deemed a hot spot or hot state and hot transition, and various optimizations may be selectively applied, as described elsewhere. State 540 and transition 522, also having relatively high weights, also may deemed a hot spot or hot state and hot transition, and various optimizations may be selectively applied depending, for example, on various considerations and constraints, such as memory cost of applying further optimizations and availability of memory in the particular hardware as may be determined from specific hardware information input 104.

FIG. 6 is a graphical representation of a portion of a finite state machine such as that represented by source code input 102 and state transition table 300. When a looped state, such as state 600, is recognized in the canonical state transition table representing the source code input 102 (e.g., state transition table 300) a state loop generation transformation (such as, e.g., transformation 404) may be applied to generate compiled code that is smaller and more efficient compared, for example, to code that branches back to the top of a switch statement with a separate case for each looped state.

FIG. 7 illustrates an example of a “next state in-lining” transformation of generated or compiled code for applying an FSM-specific optimization in accordance with an embodiment. An optimization may be FSM-specific insofar as it applies to the particular finite state machine, as represented by the state transition table or graphical representation, independent of any of a number of possible source code implementations of the same finite state machine. Thus, the left side of FIG. 7 shows code for implementing a finite state machine that includes states S1, S2, and S3 and having transition structure such that S2 is the to-state only of S1 as indicated by source code comment “/* assume only S1 transition to S2 */”. In applying the “next state in-lining” transformation to this source code for optimizing a finite state machine with this particular state-transition configuration, the compiler of system 100 can perform the optimization of eliminating case S2, as seen on the right side of FIG. 7. The resulting transformed code is smaller (as seen by comparing the left and right side of FIG. 7) and faster by not having to execute a return to the switch statement to find case S2 (instead, performing “input=read_next_input( );”), yet still performing the actions required of state S2 (e.g., “if (input=‘b’) state=• • • do_something2( );”).

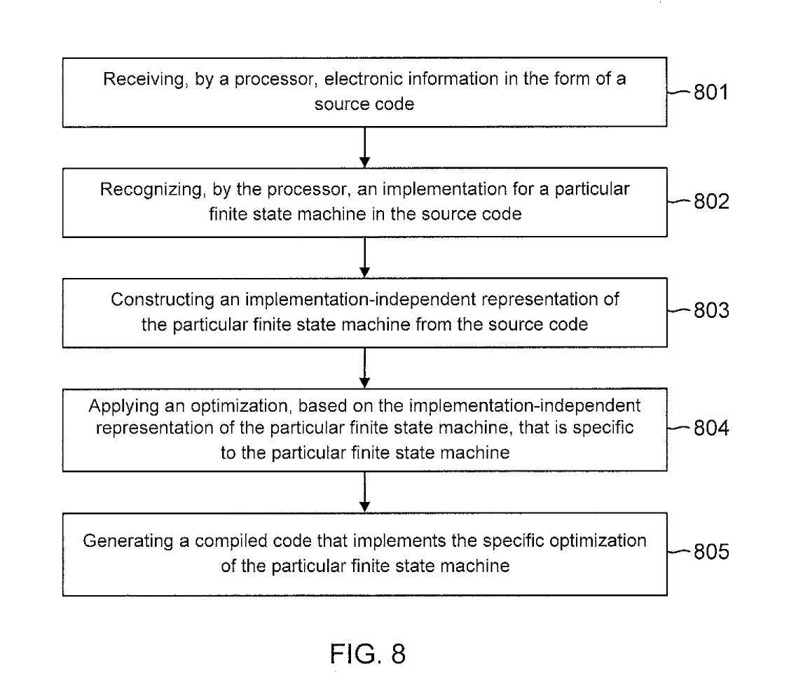

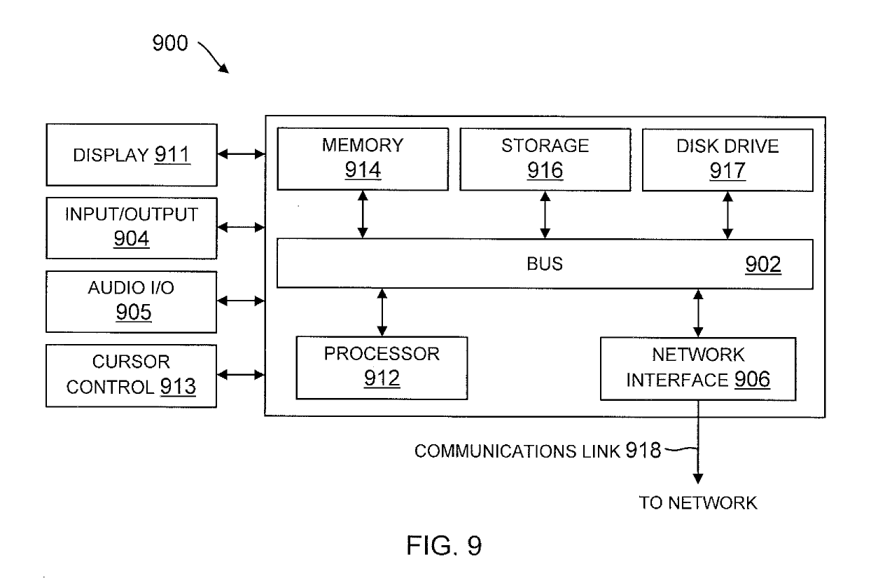

FIG. 8 is a process flow diagram illustrating a method for operating a compiler for optimizing finite state machines, in accordance with one or more embodiments. At step 801, the method may include receiving by a processor (e.g. system 100 as shown in FIG. 1 or computer system 900 shown in FIG. 9) electronic information in the form of a source code, such as input source code 102 as seen in FIG. 2.

At step 802, the method may include recognizing, by the processor, an implementation for a particular finite state machine in the source code. Step 802 may include various processes such as lexical analysis and parsing of input source code 102, for example, and operations such as identifying state variables, identifying state transitions, identifying input variables, populating (e.g., constructing) a state transition table, and identifying actions.

At step 803, the method may include constructing an implementation-independent representation—e.g., canonical representation such as a graphical representation (FIGS. 5, 6) or state transition table representation (FIG. 3)—of the particular finite state machine from the source code.

At step 804, the method may include applying an optimization based on the implementation-independent representation of the particular finite state machine (e.g., an FSM-specific optimization) that is specific to the particular finite state machine and further taking into account constraints of the particular target hardware (as provided by specific hardware information input 104. Such FSM-specific optimizations may include, for example, state transition table transposing (e.g., checking current state first vs. checking current input first); generating optimal control flow for target hardware (e.g., using switch statement vs. if/else statement vs. predicates) based on specific hardware information input 104; generating state loops for looped state transitions (e.g., as shown in FIG. 6 and transformation 404 of FIG. 4); merging indistinguishable states; eliminating unreachable states; placing code for hot transitions outside of switch statements (e.g., as shown in FIG. 4); and providing next state in-lining for hot spots (e.g., as shown in FIG. 7).

At step 805, the method may include generating, by the processor, a compiled code that implements the optimizations specific to the particular finite state machine. For example, next-state in-lining, an example of which is illustrated in FIG. 7, or transition table transpose, an example of which is illustrated between FIG. 2 and FIG. 4, may be applied to the compiled code.

Referring now to FIG. 9, an exemplary computer system 900 suitable for implementing on one or more devices of the computing system in FIG. 1 is depicted in block diagram format. In various implementations, a device that includes computer system 900 may comprise a personal computing device (e.g., a smart phone, a computing tablet, a personal computer, laptop, PDA, Bluetooth device, key FOB, badge, etc.) that is capable of communicating with a network. The system for using a smartphone for remote interaction with visual user interfaces may utilize a network computing device (e.g., a network server) capable of communicating with the network. It should be appreciated that each of the devices utilized by users, the system for using a smartphone for remote interaction with visual user interfaces may be implemented as computer system 900 in a manner as follows.

Computer system 900 can include a bus 902 or other communication mechanism for communicating information data, signals, and information between various components of computer system 900. Components include an input/output (I/O) component 904 that processes a user action, such as selecting keys from a keypad/keyboard, selecting one or more buttons or links, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. A transceiver or network interface 906 transmits and receives signals between computer system 900 and other devices, such as another user device, a merchant server, or a payment provider server via a network. In an embodiment, the transmission is wireless, although other transmission mediums and methods may also be suitable. A processor 912, which can be a micro-controller, digital signal processor (DSP), or other hardware processing component, processes these various signals, such as for display on computer system 900 or transmission to other devices over a network via a communication link 218. Processor 912 may also control transmission of information, such as cookies or IP addresses, to other devices.

Components of computer system 900 also may include any or all of a system memory component 914 (e.g., RAM), a static storage component 916 (e.g., ROM), or a disk drive 917. Computer system 900 may perform specific operations by processor 912 and other components by executing one or more sequences of instructions contained in system memory component 914. Logic may be encoded in a computer readable medium, which may refer to any medium that participates in providing instructions to processor 912 for execution. Such a medium may take many forms, including but not limited to, non-volatile media, volatile media, and transmission media. In various implementations, non-volatile media includes optical or magnetic disks, volatile media includes dynamic memory, such as system memory component 914, and transmission media includes coaxial cables, copper wire, and fiber optics, including wires that comprise bus 902. In an embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments, execution of instruction sequences for practicing the embodiments may be performed by a computer system. In various other embodiments, a plurality of computer systems coupled by a communication link (e.g., LAN, WLAN, PTSN, or various other wired or wireless networks) may perform instruction sequences to practice the embodiments in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code or data, may be stored on one or more computer readable and executable mediums. It is also contemplated that software identified herein may be implemented using one or more general purpose or specific purpose computers or computer systems, networked or otherwise. Where applicable, the ordering of various steps described herein may be changed, combined into composite steps, or separated into sub-steps to provide features described herein.

Embodiments described herein illustrate but do not limit the disclosure. It should also be understood that numerous modifications and variations are possible in accordance with the principles of the present disclosure. Accordingly, the scope of the disclosure is best defined only by the following claims.

What is claimed is:

1. A computer system, comprising:
a processor; and
a data storage device including a computer-readable medium having computer readable code for instructing the processor that, when executed by the processor, causes the processor to perform operations comprising:
receiving, by the processor, electronic information in the form of a source code;
recognizing, by the processor, an implementation for a particular finite state machine in the source code;
constructing an implementation-independent representation of the particular finite state machine from the source code;
applying an optimization, based on the implementation-independent representation of the particular finite state machine, that is specific to the particular finite state machine; and
generating, by the processor, a compiled code that implements the specific optimization of the particular finite state machine.

2. The computer system of claim 1, wherein constructing the implementation-independent representation of the particular finite state machine further comprises:
constructing a state transition table representation of the particular finite state machine.

3. The computer system of claim 1, wherein the recognizing further comprises:
identifying a loop in the source code;
identifying a state variable occurring in the source code loop;
identifying a state transition in the source code loop;
identifying an input variable in the source code loop;
populating a state transition table based on the state variable, the state transition, and the input variable; and
identifying actions in the source code loop that are not instructions for state transition condition checking.

4. The computer system of claim 1, wherein applying optimization further comprises:
determining a hot spot state and associated transitions; and
wherein generating source code further comprises:
generating source code specifically for the hot spot and associated transitions that trades code size for execution speed.

5. The computer system of claim 1, wherein applying optimization further comprises:
eliminating unreachable states of the particular finite state machine; and
merging indistinguishable states of the particular finite state machine.

6. The computer system of claim 1, wherein applying optimization further comprises:
constructing a state transition table representation of the particular finite state machine;
transposing the state transition table; and
generating source code to implement the particular finite state machine based on the transposed state transition table.

7. The computer system of claim 1, wherein generating source code further comprises:
generating a source code loop for a looped state transition of the particular finite state machine.

8. The computer system of claim 1, wherein generating source code further comprises:
based on the specific optimization, generating source code employing next-state in-lining.

9. The computer system of claim 1, wherein the operations further comprise:
receiving information about the target hardware; and
choosing between competing optimizations specific to the particular finite state machine based on the information received about the target hardware.

10. The computer system of claim 1, wherein generating source code further comprises:
choosing between competing source code implementations for the optimization specific to the particular finite state machine based on information received about the target hardware.

11. A method comprising:
receiving, by a computer processor, electronic information in the form of a source code;
recognizing, by the processor, an implementation for a particular finite state machine in the source code;
constructing, by the processor, an implementation-independent representation of the particular finite state machine from the source code;
applying, by the processor, an optimization, based on the implementation-independent representation of the particular finite state machine, that is specific to the particular finite state machine; and
generating, by the processor, a compiled code that implements the specific optimization of the particular finite state machine.

12. The method of claim 11, wherein constructing the implementation-independent representation of the particular finite state machine further comprises:
constructing a state transition table representation of the particular finite state machine.

13. The method of claim 11, wherein the recognizing further comprises:
identifying a loop in the source code;
identifying a state variable occurring in the source code loop;
identifying a state transition in the source code loop;
identifying an input variable in the source code loop;
populating a state transition table based on the state variable, the state transition, and the input variable; and
identifying actions in the source code loop that are not instructions for state transition condition checking.

14. The method of claim 11, wherein applying optimization further comprises:
determining a hot spot state and associated transitions; and
wherein generating source code further comprises:
generating source code specifically for the hot spot and associated transitions that trades code size for execution speed.

15. The method of claim 11, wherein applying optimization further comprises:
eliminating unreachable states of the particular finite state machine; and
merging indistinguishable states of the particular finite state machine.

16. The method of claim 11, wherein applying optimization further comprises:
constructing a state transition table representation of the particular finite state machine;
transposing the state transition table; and
generating source code to implement the particular finite state machine based on the transposed state transition table.

17. The method of claim 11, wherein generating source code further comprises:
generating a source code loop for a looped state transition of the particular finite state machine.

18. The method of claim 11, further comprising:
receiving information about the target hardware; and
choosing between competing optimizations specific to the particular finite state machine based on the information received about the target hardware.

19. The method of claim 11, wherein generating source code further comprises:
choosing between competing source code implementations for the optimization specific to the particular finite state machine based on information received about the target hardware.

20. A computer program product comprising a non-transitory, computer readable medium having computer readable and executable code for instructing one or more processors to perform a method, the method comprising:
receiving, by a computer processor, electronic information in the form of a source code;
recognizing, by the processor, an implementation for a particular finite state machine in the source code;
constructing, by the processor, an implementation-independent representation of the particular finite state machine from the source code;
applying, by the processor, an optimization, based on the implementation-independent representation of the particular finite state machine, that is specific to the particular finite state machine; and
generating, by the processor, a compiled code that implements the specific optimization of the particular finite state machine.
